(19) United States
(12) Patent Application Publication
(10) Pub. No.: US 2026/0220904 A1
(43) Pub. Date: Jul. 30, 2026

(54) HUMAN-COMPUTER INTERACTION SYSTEM, METHOD, AND APPARATUS FOR MIXED REALITY

(71) Applicant: Suzhou Firefly Mixed Reality Technology Co., LTD, Suzhou (CN)

(72) Inventors: Ke XU, Suzhou (CN); Peng SHAO, Suzhou (CN)

(73) Assignee: Suzhou Firefly Mixed Reality Technology Co., LTD, Suzhou (CN)

(21) Appl. No.: 19/408,510

(22) Filed: Dec. 4, 2025

Related U.S. Application Data
(63) Continuation of application No. PCT/CN2024/094098, filed on May 19, 2024.

(30) Foreign Application Priority Data
Jun. 5, 2023 (CN) 202310653630.8

(51) Int. Cl. G06T 19/20; G06T 19/00

(52) U.S. Cl. CPC G06T 19/20; G06T 19/006; G06T 2219/2004; G06T 2219/2012; G06T 2219/2016

(57) ABSTRACT

The present application relates to a human-computer interaction system, method, and apparatus for mixed reality. The method includes: presentation process design, including: designing at least one presentation step, where the presentation step contains at least one virtual content item to be presented; and designing a trigger condition for each presentation step; content arrangement, including: configuring attributes of the virtual content item, where the attributes include at least a placement pose of the virtual content item in a 3D space; and presentation use, including: presenting the corresponding virtual content item based on the configured attributes in each presentation step. The present application adopts no-code methods to enable clients without relevant software development experience to edit, generate, and use various virtual content items, thereby eventually achieving the objective of displaying corresponding virtual resources in the real world based on client requirements.

### TECHNICAL FIELD

The present application relates to the field of mixed reality devices, and in particular, to a human-computer interaction system, method, and apparatus for mixed reality.

### BACKGROUND

Currently, developing custom software for mixed reality (MR), augmented reality (AR), and virtual reality (VR) (collectively referred to as XR) head-mounted display devices often requires a significant investment in specialized human resources. To develop high-quality XR software products, development teams must master professional development tools such as Unreal Engine and Unity, be proficient in programming languages like C++ and C #, and possess extensive experience in software design, development, debugging, and project management. However, in many commercial and industrial XR application scenarios, end users often lack software development teams that meet these requirements, while temporarily hiring outsourcing teams presents the end users with challenges such as extended development cycles, high budgets, and project management difficulties.

Currently, in commercial and industrial settings, a common requirement for XR technology includes displaying corresponding virtual resources in the real world based on client requirements. How to adopt no-code methods to help users without relevant software development experience edit, generate, and use virtual content through a human-computer interaction system, method, and apparatus is a technical problem urgently needing resolution by those skilled in the art.

### SUMMARY

The present application provides a human-computer interaction system, method, and apparatus for mixed reality to resolve the foregoing technical problems.

To resolve the foregoing technical problems, the present application provides a human-computer interaction method for mixed reality, including:
presentation process design, including: designing at least one presentation step, where the presentation step contains at least one virtual content item to be presented; and designing a trigger condition for each presentation step;
content arrangement, including: configuring attributes of the virtual content item, where the attributes include at least a placement pose of the virtual content item in a 3D space; and
presentation use, including: presenting the corresponding virtual content item based on the configured attributes in each presentation step.

In some embodiments, the virtual content item includes at least one or more of the following: text, images, videos, audio, 3D models, and animations.

In some embodiments, a plurality of presentation steps are provided, and the plurality of presentation steps are sequentially executed in a fixed order.

In some embodiments, a plurality of presentation steps are provided, and the plurality of presentation steps are executed based on the trigger conditions.

In some embodiments, the trigger conditions include at least one of a time condition, a position condition, an orientation condition, a user input event, a pre-stored program script, and a custom program script.

In some embodiments, the user input event includes pressing a physical button or inputting a command signal.

In some embodiments, the trigger condition is a combination of a plurality of trigger conditions that have undergone logical operations.

In some embodiments, the attributes of the virtual content item further include size, color, animation behavior, playback speed, or audio volume of the virtual content item.

In some embodiments, a configuration manner of the placement pose of the virtual content item in the 3D space includes:
obtaining a reference position based on the 3D space;
moving the virtual content item to a target placement position via an anchor bound to the virtual content item, calculating and recording a relationship between the anchor and the reference position, and defining the position of placement as an anchor position; and
determining the placement pose of the virtual content item based on the anchor position.

In some embodiments, the reference position is obtained by identifying and localizing a reference object in the 3D space.

In some embodiments, the reference object includes at least an environment, an object, or a marker.

In some embodiments, the anchor is a handheld mobile device.

In some embodiments, the anchor carries a localization pattern, and the anchor position is obtained by identifying and localizing the localization pattern.

In some embodiments, the localization pattern includes an image, a two-dimensional code, a barcode, or a specific graphic.

In some embodiments, an image capture device mounted on a head-mounted display device is used to identify and localize the reference object and the localization pattern.

In some embodiments, the anchor position is determined as the placement pose of the virtual content item.

In some embodiments, the placement pose of the virtual content item is determined after a mathematical operation is performed on the anchor position.

A second aspect of the present application provides a human-computer interaction system for mixed reality, including:
a presentation process design module, configured to: design at least one presentation step, where the presentation step contains at least one virtual content item to be presented; and design a trigger condition for each presentation step;
a content arrangement module, configured to configure attributes of the virtual content item, where the attributes include at least a placement pose of the virtual content item in a 3D space; and
a presentation use module, configured to present the corresponding virtual content item based on the configured attributes in each presentation step.

In some embodiments, the virtual content item includes at least one or more of the following: text, images, videos, audio, 3D models, and animations.

In some embodiments, a plurality of presentation steps are provided, and the plurality of presentation steps are sequentially executed in a fixed order.

In some embodiments, a plurality of presentation steps are provided, and the plurality of presentation steps are executed based on the trigger conditions.

In some embodiments, the trigger conditions include at least one of a time condition, a position condition, an orientation condition, a user input event, a pre-stored program script, and a custom program script.

In some embodiments, the user input event includes pressing a physical button or inputting a command signal.

In some embodiments, the trigger condition is a combination of a plurality of trigger conditions that have undergone logical operations.

In some embodiments, the attributes of the virtual content item further include size, color, animation behavior, playback speed, or audio volume of the virtual content item.

In some embodiments, a configuration manner of the placement pose of the virtual content item in the 3D space includes:
obtaining a reference position based on the 3D space;
moving the virtual content item to a target placement position via an anchor bound to the virtual content item, calculating and recording a relationship between the anchor and the reference position, and defining the position of placement as an anchor position; and
determining the placement pose of the virtual content item based on the anchor position.

In some embodiments, the reference position is obtained by identifying and localizing a reference object in the 3D space.

In some embodiments, the reference object includes at least an environment, an object, or a marker.

In some embodiments, the anchor is a handheld mobile device.

In some embodiments, the anchor carries a localization pattern, and the anchor position is obtained by identifying and localizing the localization pattern.

In some embodiments, the localization pattern includes an image, a two-dimensional code, a barcode, or a specific graphic.

In some embodiments, an image capture device mounted on a head-mounted display device is used to identify and localize the reference object and the localization pattern.

In some embodiments, the anchor position is determined as the placement pose of the virtual content item.

In some embodiments, the placement pose of the virtual content item is determined after a mathematical operation is performed on the anchor position.

A third aspect of the present application further provides a human-computer interaction apparatus for mixed reality, used in the method as described above, where the apparatus includes at least one processor, at least one handheld mobile device, and at least one head-mounted display device, where
the processor is configured to perform the step of presentation process design;
the handheld mobile device is configured to cooperate with the head-mounted display device to perform the step of content arrangement; and
the head-mounted display device is configured to perform the step of presentation use.

In some embodiments, the processor is integrated in the head-mounted display device.

In some embodiments, the processor is integrated in the handheld mobile device.

Compared with the prior art, the human-computer interaction system, method, and apparatus for mixed reality provided in the present application adopt no-code methods to enable clients without relevant software development experience to edit, generate, and use various virtual content items, thereby eventually achieving the objective of displaying corresponding virtual resources in the real world based on client requirements.

### BRIEF DESCRIPTION OF THE DRAWINGS

FIG. 1 is a block diagram of a human-computer interaction system for mixed reality according to a specific embodiment of the present application (a content arrangement phase);

FIG. 2 is a block diagram of a human-computer interaction system for mixed reality according to a specific embodiment of the present application (a presentation use phase);

FIG. 3 is a flowchart of a presentation process design phase and a content arrangement phase according to a specific embodiment of the present application;

FIG. 4 is a flowchart of a presentation process design phase and a content arrangement phase according to another specific embodiment of the present application;

FIG. 5 is a flowchart of a presentation use phase according to a specific embodiment of the present application; and

FIG. 6 to FIG. 9 are schematic diagrams of correspondence of trigger conditions triggering presentation steps according to specific embodiments of the present application.

In the figures: 10—reference object, 11—reference coordinate system, 20—handheld mobile device, 21—localization pattern, 22—virtual content item, and 30—head-mounted display device.

### DETAILED DESCRIPTION OF THE EMBODIMENTS

To describe the technical solutions of the embodiments of the present application more clearly, the following briefly describes the accompanying drawings required for describing the embodiments. Apparently, the accompanying drawings in the following description show only some examples or embodiments of the present application, and a person of ordinary skill in the art may still apply the present application to other similar scenarios according to these accompanying drawings without creative efforts. Unless apparent from the language context or otherwise indicated, the same symbol in the drawings represents the same structure or operation.

As shown in the present application and claims, unless the context clearly suggests an exception, the words “a”, “one”, “an”, and/or “the” do not refer specifically to the singular, but may also include the plural. Generally, the terms “include” and “comprise” suggest only the inclusion of clearly identified steps and elements that do not constitute an exclusive list, and the method or device may also include other steps or elements.

While the present application makes various references to certain modules in the system according to the embodiments of the present application, any number of different modules may be used and executed on a client and/or server of a mixed reality device. The modules are merely illustrative, and different aspects of the system and method may be implemented using different modules.

Flowcharts are used in the present application to illustrate operations performed by the system according to the embodiments of the present application. It should be understood that the preceding or following operations are not necessarily performed precisely sequentially. Instead, various steps may be processed in reverse order or simultaneously. Furthermore, other operations may be added to these processes, or one or more operations may be removed from these processes.

Embodiments of the present application may be applied to various application scenarios, for example: 1) creating immersive mixed-reality exhibition experiences at trade shows or exhibition halls, complementing physical products with virtual effects; 2) using mixed reality to present step-by-step operational guidance in employee skill training; and 3) enabling rapid virtual equipment layout previews for clients during sales processes of equipment suppliers.

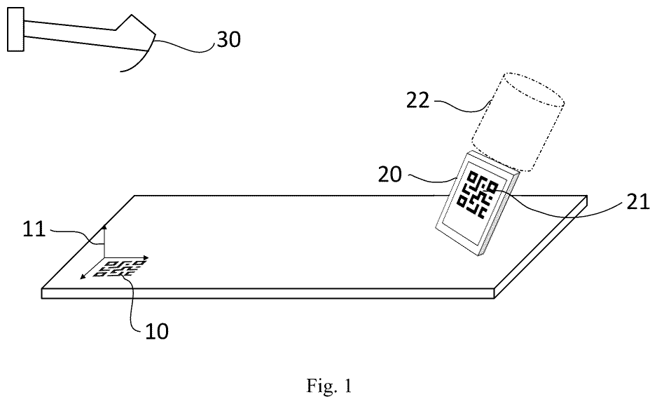

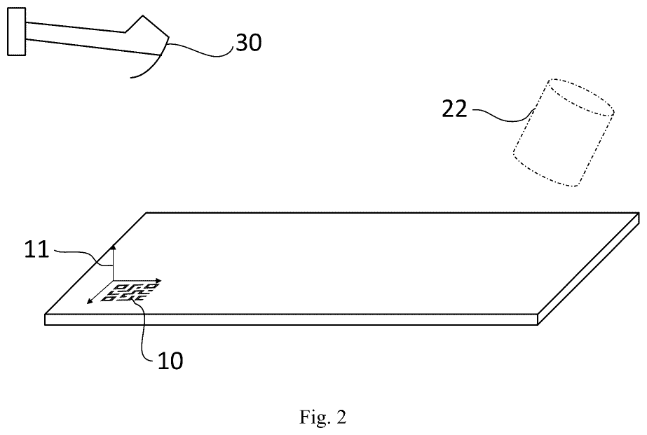

Referring to FIG. 1 to FIG. 9, a human-computer interaction system for mixed reality provided in the present application includes: a presentation process design module, configured to: design at least one presentation step, where the presentation step contains at least one virtual content item 22 to be presented; and design a trigger condition for each presentation step;
a content arrangement module, configured to configure attributes of the virtual content item 22, where the attributes include at least a placement pose of the virtual content item 22 in a 3D space; and
a presentation use module, configured to present the corresponding virtual content item 22 based on the configured attributes in each presentation step.

In some embodiments, the presentation process design module, the content arrangement module, and the presentation use module may be interconnected through at least one piece of server-side software for data communication and synchronization across various phases.

In some embodiments, the virtual content item 22 includes at least one or more of the following: text, images, videos, audio, 3D models, and animations.

In some embodiments, a plurality of presentation steps are provided, and the plurality of presentation steps may be sequentially executed in a fixed order.

In some embodiments, a plurality of presentation steps are provided, and the plurality of presentation steps may be executed based on the trigger conditions.

In some embodiments, the trigger conditions may include at least one of a time condition, a position condition, an orientation condition, a user input event, a pre-stored program script, and a custom program script.

In some embodiments, the user input event may include pressing a physical button or inputting a command signal.

In some embodiments, the trigger condition may be a combination of a plurality of trigger conditions that have undergone logical operations.

In some embodiments, the attributes of the virtual content item 22 may further include size, color, animation behavior, playback speed, or audio volume of the virtual content item 22.

In some embodiments, a configuration manner of the placement pose of the virtual content item 22 in the 3D space includes:
obtaining a reference position based on the 3D space;
moving the virtual content item 22 to a target placement position via an anchor (for example, a handheld mobile device 20) bound to the virtual content item 22, calculating and recording a relationship between the anchor and the reference position, and defining the position of placement as an anchor position; and
determining the placement pose of the virtual content item 22 based on the anchor position.

In some embodiments, the reference position may be obtained by identifying and localizing a reference object 10 in the 3D space.

In some embodiments, the reference object may include at least an environment, an object, or a marker.

In some embodiments, the anchor carries a localization pattern 21, and the anchor position is obtained by identifying and localizing the localization pattern 21.

In some embodiments, the localization pattern 21 may include an image, a two-dimensional code, a barcode, or a specific graphic.

In some embodiments, an image capture device mounted on a head-mounted display device 30 is used to identify and localize the reference object 10 and the localization pattern 21.

In some embodiments, the anchor position is determined as the placement pose of the virtual content item 22.

In some embodiments, the placement pose of the virtual content item 22 is determined after a mathematical operation is performed on the anchor position.

It should be understood that the aforementioned system and its modules may be implemented in various ways. For example, in some embodiments, the system and its modules may be implemented through hardware, software, or a combination of software and hardware. The hardware portion may be implemented using dedicated logic; the software portion may be stored in a memory and executed by an appropriate instruction execution system, for example, a microprocessor or specially designed hardware. Those skilled in the art will appreciate that the aforementioned method and system may be implemented using computer-executable instructions and/or included in processor control code, such code being provided, for example, on a carrier medium such as a disk, a CD-ROM, or a DVD-ROM, a programmable memory such as a read-only memory (firmware), or a data carrier such as an optical or electronic signal carrier. The system and its modules of the present application may be implemented not only through hardware circuits such as very-large-scale integration circuits or gate arrays, semiconductors such as logic chips or transistors, or programmable hardware devices such as field-programmable gate arrays or programmable logic devices, but also through software executed by various types of processors, or through a combination of the aforementioned hardware and software.

It should be noted that the foregoing descriptions of the system and its modules are provided for descriptive convenience only and are not intended to limit the present application to the scope of the cited embodiments. It will be understood by those skilled in the art that, upon understanding the principles of the system, various modules may be arbitrarily combined or form subsystems connected to other modules without departing from these principles. For example, in some embodiments, the presentation process design module, the content arrangement module, and the presentation use module may be distinct units within one system, or one unit may implement the functions of two or more of the aforementioned modules. In another example, all modules may share a storage device, or each unit may have its own storage device. Such variations all fall within the scope of protection of the present application.

A human-computer interaction method for mixed reality provided in the present application, as shown in FIG. 1 to FIG. 9, includes the following steps:
Presentation process design, including: designing at least one presentation step, where the presentation step contains at least one virtual content item 22 to be presented; and designing a trigger condition for each presentation step. When designing a presentation process, a user may create, modify, or delete one or more presentation steps, and specify a virtual content item 22 to be presented for each presentation step.

Content arrangement, including: configuring attributes of the virtual content item 22, where the attributes include at least a placement pose (position and/or orientation) of the virtual content item 22 in a 3D space. In the content arrangement phase, the content arrangement module and the head-mounted display device 30 in the system may be used to help a user configure the placement pose and other attributes of the virtual content item 22 in the 3D space.

Presentation use, including: presenting the corresponding virtual content item 22 based on the configured attributes in each presentation step. In this phase, the head-mounted display device 30 performs presentation based on the presentation step and the trigger condition in the presentation process design phase and the pose and other attributes of the virtual content item 22 generated in the content arrangement phase.

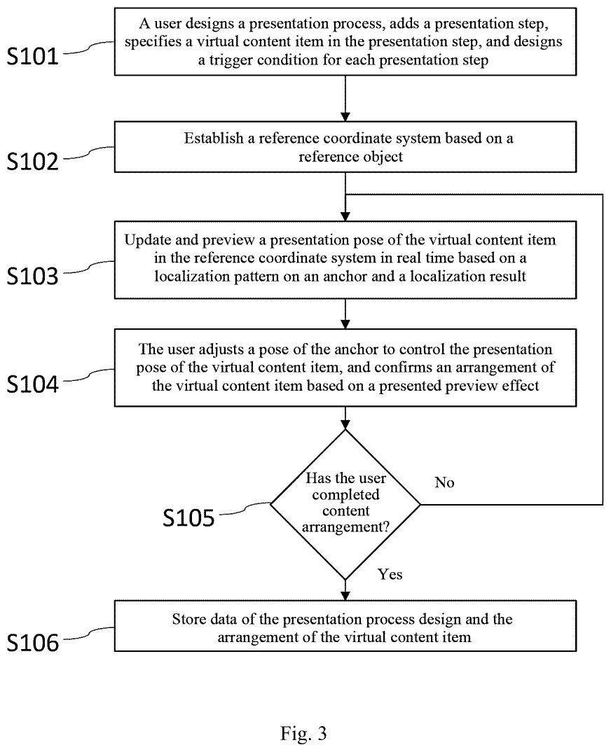

FIG. 3 describes an implementation process of the presentation process design and the content arrangement. In S101, a user first designs a presentation process, defines each presentation step in the presentation process, a virtual content item 22 to be presented in the presentation step, and a trigger condition for initiation of each presentation step or a step-to-step transition. Subsequently, the user enters the content arrangement phase to arrange the virtual content item 22. In S102, the head-mounted display device 30 may be used to establish a reference coordinate system 11 based on the design of the user. Next, in S103, the head-mounted display device 30 is used to identify and localize the localization pattern 21 displayed by the handheld mobile device 20 in the environment, and based on a localization result, the virtual content item 22 that is currently being arranged by the user is overlaid near the handheld mobile device 20, making the virtual content item 22 move along with the handheld device move 20. In S104, the user adjusts the pose of the handheld mobile device 20 to adjust a pose of the virtual content item 22, and confirms the arrangement and placement of the virtual content item 22 based on a preview effect on the head-mounted display device 30. In S105, when the user needs to arrange more virtual content items 22, the user may select a virtual content item 22 to be arranged and repeat S103 and S104. If the user choose to complete the content arrangement, data of the presentation process design and the content arrangement is stored in S106.

In some embodiments, S106 may be performed synchronously with other processes. For example, the user may store related data when having any change to be made to the presentation process and the content arrangement or deciding to store the current design.

In some embodiments, the presentation process design and the content arrangement may be performed synchronously. For example, when performing the content arrangement, the user may enter the presentation process design phase to add or delete a presentation step, change a trigger condition for a presentation step, add or delete a corresponding virtual content item 22, or move a virtual content item 22 into a different presentation step.

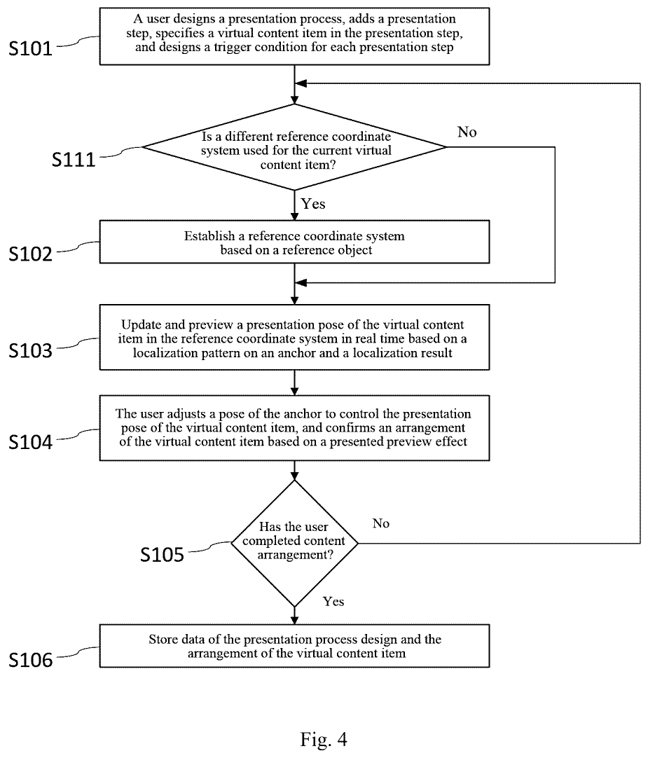

FIG. 4 describes another embodiment of the presentation process design and the content arrangement phase. Compared with the embodiment described in FIG. 3, in this embodiment, the user may define different reference coordinate systems 11 for different virtual content items 22. When starting to arrange one virtual content item 22, in S111, the user determines, based on the design in S101 or the current selection by the user, whether a different reference coordinate system 11 needs to be established. For example, when a reference coordinate system corresponding to the virtual content item 22 is different from the current reference coordinate system, no reference coordinate system has been established currently, or the user specifies a new reference coordinate system, the process turns from S111 to S102 to establish a reference coordinate system. If a different reference coordinate system does not need to be established, the established reference coordinate system is used, and the process directly turns to S103 to start the arrangement of the virtual content item 22.

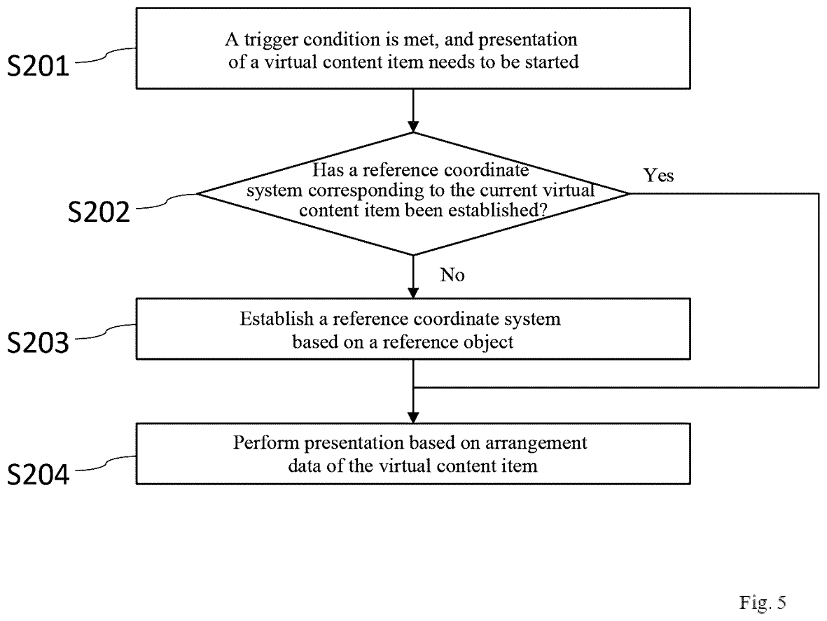

FIG. 5 describes an embodiment of the presentation use phase. In S201, the trigger condition designed by the user is met, and the head-mounted display device 30 is about to present a corresponding virtual content item 22. In S202, it is determined whether the reference coordinate system 11 corresponding to the virtual content item 22 has been established. If the reference coordinate system 11 has not been established, in S203, the reference object 10 is identified and localized in the environment, and the reference coordinate system 11 is established. In S204, presentation is performed in the reference coordinate system 11 based on arrangement data of the virtual content item 22.

In some embodiments, the virtual content item 22 includes at least one or more of the following: text, images, videos, audio, 3D models, and animations. For example, the virtual content item 22 may be an arrow for indicating a component position; or may be a text or audio/video introduction; or may be a demonstration animation of a use method.

In some embodiments, the plurality of presentation steps may be sequentially executed in a fixed order. For example, when a start key is pressed, a presentation step 1 starts to be executed, a presentation step 2 starts to be executed after the playback is completed (or after a period of time following the completion of the playback), and so on, until the presentation of all presentation steps is completed.

In some embodiments, the plurality of presentation steps may be executed based on the trigger conditions. In other words, the presentation order of the plurality of presentation steps may be linear or may be nonlinear. For example, the plurality of presentation steps are executed simultaneously, or the start or termination of the presentation steps is determined based on conditions defined by the user.

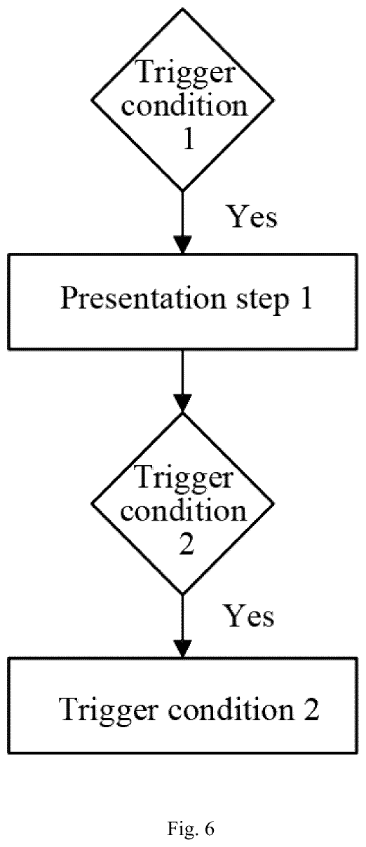

FIG. 6 describes a linear step design in the presentation process design phase. When a trigger condition 1 is met, the execution of a presentation step 1 is triggered, and subsequently, when a trigger condition 2 is met, the execution of a presentation step 2 is triggered.

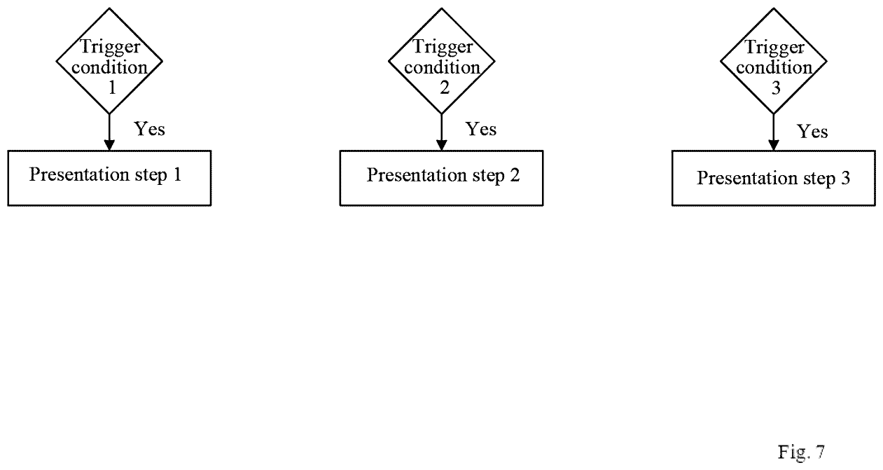

FIG. 7 describes a nonlinear step design in the presentation process design phase. When a trigger condition 1 is met, the execution of a presentation step 1 is triggered. When a trigger condition 2 is met, the execution of a presentation step 2 is triggered. When a trigger condition 3 is met, the execution of a presentation step 3 is triggered. The presentation processes of the three presentation steps are independent of each other and do not affect each other.

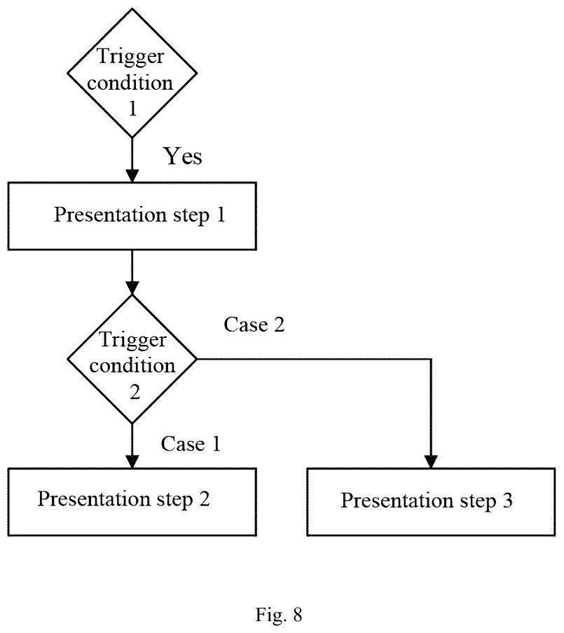

FIG. 8 describes a nonlinear step design in the presentation process design phase. When a trigger condition 1 is met, a presentation step 1 is triggered. Subsequently, when a trigger condition 2 is met, in Case 1, the execution of a presentation step 2 is triggered, and in Case 2, the execution of a presentation step 3 is triggered.

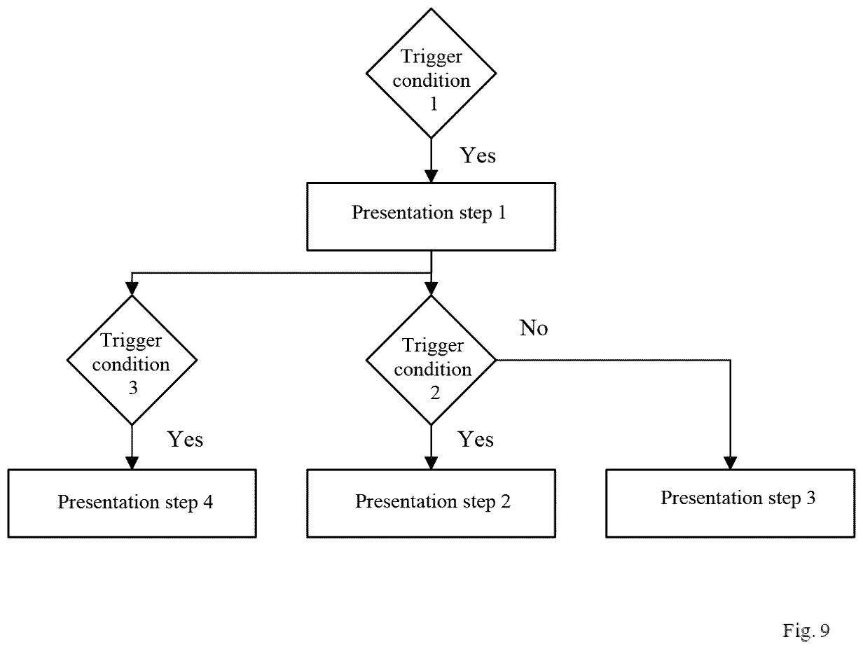

FIG. 9 describes another linear step design in the presentation process design phase. After a presentation step 1 is executed, a plurality of subsequent conditions may exist. When a trigger condition 3 is met, the execution of a presentation step 4 is triggered. When a trigger condition 2 is met, the execution of a presentation step 2 is triggered. When the trigger condition 2 is not met, the execution of a presentation step 3 is triggered.

In some embodiments, the trigger conditions may be in various forms, for example, a time condition, a position condition, an orientation condition, a user input event, a pre-stored program script, and a custom program script.

In some embodiments, the trigger condition may be a timer. For example, the execution of a presentation step is triggered after a predefined period of time following the start of execution of a presentation program; or the execution of another presentation step is triggered after a predetermined period of time following the execution of one presentation step.

In some embodiments, the trigger condition may be a distance between a user of the head-mounted display device 30 and a specific position in a 3D space. For example, a presentation step specified by the trigger condition is started or stopped after the distance between the user of the head-mounted display device 30 and the specific position is less than or greater than a threshold.

In some embodiments, the trigger condition may be a spatial range. For example, a presentation step specified by the trigger condition is started or stopped when the user of the head-mounted display device 30 faces or turns away from a preset spatial area.

In some embodiments, the trigger condition may be the orientation of the head of the user of the head-mounted display device 30 in the 3D space. For example, a presentation step specified by the trigger condition is started or stopped after the head of the user of the head-mounted display device 30 enters or leaves an orientation range.

In some embodiments, the trigger condition may alternatively be a user input event, which is, for example, pressing a physical button or inputting a command signal on a user interface by the user of the head-mounted display device 30. In some embodiments, the user input event may alternatively be generated by the user of the head-mounted display device 30 through external hardware that has a data connection with the head-mounted display device 30, for example, a Bluetooth headset, a smartphone, or a tablet computer.

In some embodiments, the trigger condition may alternatively be a pre-stored program script, for example, a trigger condition set based on a visual algorithm or a program algorithm. For example, a presentation step is triggered when a specific scene, object, or the like falls within a visual range of the head-mounted display device 30. The trigger condition may alternatively be a trigger condition set based on a network data event. For example, a specific presentation step is triggered after a device is connected to a specified network. In some embodiments, the user may define a trigger condition as required through a custom program script.

In some embodiments, the trigger condition may alternatively be a combination of a plurality of trigger conditions that have undergone logical operations. For example, a trigger condition C may be defined as a condition A and a condition B both being met. For another example, the condition C may be defined as at least one of the condition A and the condition B being met.

In some embodiments, the attributes of the virtual content item 22 may further include other presentation-related attribute information such as size, color, animation behavior, playback speed, or audio volume of the virtual content item 22, for example, the color of an indication arrow, or the playback speed and audio volume of audio.

In some embodiments, a configuration manner of the placement pose of the virtual content item 22 in the 3D space includes:
obtaining a reference position based on the 3D space, that is, establishing the reference coordinate system 11;
moving the virtual content item 22 to a target placement position via an anchor bound to the virtual content item 22, calculating and recording a relationship (that is, the coordinates of the anchor in the reference coordinate system 11) between the anchor and the reference position, and defining the position of placement as an anchor position; and
determining the placement pose of the virtual content item 22 based on the anchor position.

In some embodiments, the reference position may be obtained by identifying and localizing a reference object 10 in the 3D space. In some embodiments, pose information for the final presentation of the virtual content item 22 is defined in at least one reference coordinate system 11. The reference coordinate system 11 may be defined on a reference object 10. The reference object 10 may be a fixed environment, for example, a room or a site; or may be defined on an object, for example, industrial equipment, furniture, a home appliance, an electronic product, or a vehicle; or may be a marker, for example, a specific pattern marker.

In some embodiments, the reference coordinate system 11 may alternatively be defined to synchronously move and/or rotate along with head-mounted display device 30, that is, the pose of the reference coordinate system 11 and the pose of the head-mounted display device 30 change in the same manner or trend. In some embodiments, if the reference coordinate system 11 is not defined on the head-mounted display device 30, the head-mounted display device 30 may establish a reference coordinate system 11 by identifying, localizing and/or tracking at least one specific pattern marker prearranged in the environment, for example, a two-dimensional code, a barcode, or an image, and record an identified feature of the specific pattern marker, for example, encoded content of a two-dimensional code.

In some other embodiments, the head-mounted display device 30 may identify and localize the reference object 10 through a visual feature of the reference object 10, for example, a visual feature point, line, pattern or the like. In some embodiments, the user may record videos or images of the reference object 10 and use the recorded materials to perform training to obtain an artificial intelligence model for identifying and localizing the reference object 10. When the user confirms a pose that needs to be presented by the virtual content item 22, the head-mounted display device 30 calculates and records a pose of the virtual content item 22 with respect to the reference coordinate system 11. In some embodiments, after the user confirms an arrangement operation for a virtual content item 22, the content arrangement module associates a reference coordinate system 11 corresponding to the virtual content item 22 and pose information of the virtual content item 22 with information about a presentation step to which the virtual content item 22 belongs, thereby facilitating the reproduction of the arrangement of the virtual content item 22 by the user in the corresponding presentation step and the corresponding reference coordinate system 11 during the presentation use phase.

In some embodiments, the user may select, through a user interaction interface provided by the content arrangement module, a virtual content item 22 that the user currently wants to arrange, and send the information to the head-mounted display device 30 via a data communication connection, to help the head-mounted display device 30 select the correct virtual content item 22 for visual previewing and arrangement data entering. In some embodiments, the user may further make additional modifications to the attributes of the virtual content item 22 through the content arrangement module or a user interface on the head-mounted display device 30, for example, further adjust the presentation size, color, playback speed, or audio volume of the virtual content item 22.

In some embodiments, the anchor may be an entity that is easy to move and localize and that has display functionality, and preferably, is a handheld mobile device 20, for example, a mobile phone, a tablet, or a handheld display. The anchor has a regular physical structure, is easy to identify and localize, and can provide an operable user interface.

In some embodiments, the anchor carries a localization pattern 21, and the anchor position is obtained by identifying and localizing the localization pattern 21.

In some embodiments, an image capture device mounted on a head-mounted display device 30 may be used to identify and localize the reference object 10 and the localization pattern 21. For example, at least one image that contains the localization pattern 21 is obtained using a camera, an infrared camera, a depth camera, or the like, and a pose of the handheld mobile device 20 in the 3D space is calculated using a visual feature in the localization pattern 21, for example, a point, a line, or an outer contour. In some embodiments, the localization pattern 21 may be an image, a two-dimensional code, a barcode, a specific graphic, or the like.

In some embodiments, the localization pattern 21 may be prestored in the content arrangement module. In some other embodiments, the content arrangement module may download the localization pattern 21 from another device or software module, for example, built-in software of the head-mounted display device 30, the presentation process design module, or a server program. In some embodiments, the head-mounted display device 30 may use the localization pattern 21 to identify and localize the handheld mobile device 20 at least once, and subsequent localization is performed by identifying and localizing the visual feature of the handheld mobile device 20.

In some embodiments, the anchor position may be determined as the placement pose of the virtual content item 22, that is, the head-mounted display device 30 directly uses the pose in the 3D space obtained through localization as a pose for anchoring a virtual content item 22.

In some embodiments, the placement pose of the virtual content item 22 may alternatively be determined after a mathematical operation is performed on the anchor position. For example, a pose offset is added to the anchor position.

In some embodiments, the head-mounted display device 30 may select a part of the pose information obtained through localization as a pose for anchoring the virtual content item 22, for example, use position coordinates of a localization result and the orientation of the head-mounted display device 30 on the horizontal plane as the position and the orientation of the virtual content item 22, respectively.

In some embodiments, the head-mounted display device 30 may overlay the virtual content item 22 onto the real world, and update a display pose of the virtual content item 22 in real time based on the pose information obtained through localization, thereby helping the user visually preview the effect of content arrangement. The user may further confirm or cancel the result of content arrangement through the user interaction interface provided by the content arrangement module.

In some embodiments, the user may further make additional adjustments to the pose of the virtual content item 22 through the content arrangement module, for example, add an additional offset to the pose of the virtual content item 22.

It should be noted that the foregoing descriptions of the processes are for illustrative and explanatory purposes only and do not limit the scope of applicability of the present application. Those skilled in the art may make various modifications and changes to the processes under the guidance of the present application. However, these modifications and changes still fall within the scope of the present application.

Some other embodiments of the present application further provide a human-computer interaction apparatus for mixed reality, including at least one processor, at least one handheld mobile device 20, and at least one head-mounted display device 30. The processor is configured to perform the step of presentation process design. The handheld mobile device 20 is configured to cooperate with the head-mounted display device 30 to perform the step of content arrangement. The head-mounted display device 30 is configured to perform the step of presentation use.

In some embodiments, the presentation use module may be executed on a plurality of head-mounted display devices 30. When one head-mounted display device 30 has established a reference coordinate system 11, the head-mounted display device 30 may share the reference coordinate system 11 with other head-mounted display devices 30. The other head-mounted display devices 30 may indirectly calculate the reference coordinate system 11 through relative positions and orientation relationships with the head-mounted display device 30.

In some embodiments, the processor may be independent, and for example, may be an independent terminal. The processor may alternatively be integrated in the head-mounted display device 30. For example, the presentation process design module and the presentation use module are integrated in one head-mounted display device 30. The processor may alternatively be integrated in the handheld mobile device 20. For example, the presentation process design module and the content arrangement module are integrated in the same handheld mobile device 20.

The potential beneficial effects of the embodiments of the present application include, but are not limited to: (1) The present application adopts no-code methods to enable clients without relevant software development experience to edit, generate, and use various virtual content items; and (2) corresponding virtual resources may be displayed in the real world based on personalized requirements of clients.

It should be noted that different embodiments may yield different beneficial effects. In various embodiments, the achievable beneficial effects may be any one or a combination of the above, or any other beneficial effects that may be obtained.

The above content describes the present application and/or some other examples. Based on the above content, various modifications may be made to the present application. The subject matter disclosed in the present application can be implemented in different forms and examples, and the present application may be applied to numerous applications. All applications, modifications, and changes claimed in the claims fall within the scope of the present application.

Meanwhile, the present application uses specific words to describe embodiments of the present application. For example, “one embodiment”, “an embodiment”, and/or “some embodiments” mean a feature, structure, or characteristic associated with at least one embodiment of the present application. Therefore, it should be emphasized and noted that “an embodiment” or “one embodiment” or “another embodiment” mentioned twice or more in different places in this specification does not necessarily refer to the same embodiment. In addition, certain features, structures, or characteristics in one or more embodiments of the present application may be suitably combined.

Those skilled in the art will appreciate that various variations and improvements may be made to the content disclosed in the present application. For example, while the different system modules described above are all implemented through hardware devices, they may alternatively be implemented solely through software solutions, for example, by installing the system on an existing server.

All software, or part thereof, may sometimes communicate over a network such as the Internet or other communication networks. Such communication enables the software to be loaded from one computer device or processor to another.

In addition, except as expressly stated in the claims, the present application deals with the use of numbers and letters, or the use of other names, and is not intended to limit the order of the procedures and methods of the present application. While some embodiments of the present application currently considered useful are discussed in the above disclosure by way of various examples, it should be understood that class of details serve only illustrative purposes and that the additional claims are not limited to the disclosed embodiments; rather, the claims are intended to cover a combination of all amendments and equivalents consistent with the substance and scope of embodiments of the present application. For example, while the system components described above can be implemented through hardware devices, they can also be implemented through software-only solutions, such as installing the described system on an existing server or mobile device.

Similarly, it should be noted that in order to simplify the presentation of the present application disclosure and thereby aid in the understanding of one or more embodiments of the present application, the preceding descriptions of embodiments of the present application sometimes group a plurality of features into one embodiment, accompanying drawing or description thereof. However, this method of disclosure does not imply that the subject of the present application requires more features than those mentioned in the claims. In fact, the features of the embodiments are fewer than all of the features of the individual embodiments disclosed above.

Finally, it should be understood that the embodiments described in the present application are merely illustrative of the principles of the embodiments of the present application. Other variations may also fall within the scope of the present application. Accordingly, by way of example and not limitation, alternative configurations of the embodiments of the present application may be considered consistent with the teachings of the present application. Accordingly, the embodiments of the present application are not limited to those explicitly introduced and described in the present application.

1. A human-computer interaction method for mixed reality, comprising:
presentation process design, comprising: designing at least one presentation step, wherein the presentation step contains at least one virtual content item to be presented; and designing a trigger condition for each presentation step;
content arrangement, comprising: configuring attributes of the virtual content item, wherein the attributes comprise at least a placement pose of the virtual content item in a 3D space; and
presentation use, comprising: presenting the corresponding virtual content item based on the configured attributes in each presentation step.

2. The human-computer interaction method for mixed reality according to claim 1, wherein the virtual content item comprises at least one or more of the following: text, images, videos, audio, 3D models, and animations.

3. The human-computer interaction method for mixed reality according to claim 1, wherein a plurality of presentation steps are provided, and the plurality of presentation steps are sequentially executed in a fixed order.

4. The human-computer interaction method for mixed reality according to claim 1, wherein a plurality of presentation steps are provided, and the plurality of presentation steps are executed based on the trigger conditions.

5. The human-computer interaction method for mixed reality according to claim 4, wherein the trigger conditions comprise at least one of a time condition, a position condition, an orientation condition, a user input event, a pre-stored program script, and a custom program script; or the trigger condition is a combination of a plurality of trigger conditions that have undergone logical operations.

6. The human-computer interaction method for mixed reality according to claim 5, wherein the user input event comprises pressing a physical button or inputting a command signal.

7. (canceled)

8. The human-computer interaction method for mixed reality according to claim 1, wherein the attributes of the virtual content item further comprise size, color, animation behavior, playback speed, or audio volume of the virtual content item.

9. The human-computer interaction method for mixed reality according to claim 1, wherein a configuration manner of the placement pose of the virtual content item in the 3D space comprises:
obtaining a reference position based on the 3D space;
moving the virtual content item to a target placement position via an anchor bound to the virtual content item, calculating and recording a relationship between the anchor and the reference position, and defining the position of placement as an anchor position; and
determining the placement pose of the virtual content item based on the anchor position.

10. The human-computer interaction method for mixed reality according to claim 98, wherein the reference position is obtained by identifying and localizing a reference object in the 3D space, and the reference object comprises at least an environment, an object, or a marker.

11. (canceled)

12. The human-computer interaction method for mixed reality according to claim 8, wherein the anchor is a handheld mobile device, the anchor carries a localization pattern, and the anchor position is obtained by identifying and localizing the localization pattern, the localization pattern comprises an image, a two-dimensional code, a barcode, or a specific graphic.

13. (canceled)

14. (canceled)

15. The human-computer interaction method for mixed reality according to claim 10, wherein an image capture device mounted on a head-mounted display device is used to identify and localize the reference object and the localization pattern.

16. The human-computer interaction method for mixed reality according to claim 8, wherein the anchor position is determined as the placement pose of the virtual content item, or the placement pose of the virtual content item is determined after a mathematical operation is performed on the anchor position.

17. (canceled)

18. A human-computer interaction system for mixed reality, comprising:
a presentation process design module, configured to: design at least one presentation step, wherein the presentation step contains at least one virtual content item to be presented; and design a trigger condition for each presentation step;
a content arrangement module, configured to configure attributes of the virtual content item, wherein the attributes comprise at least a placement pose of the virtual content item in a 3D space; and
a presentation use module, configured to present the corresponding virtual content item based on the configured attributes in each presentation step.

19. The human-computer interaction system for mixed reality according to claim 13, wherein the virtual content item comprises at least one or more of the following: text, images, videos, audio, 3D models, and animations.

20. The human-computer interaction system for mixed reality according to claim 13, wherein a plurality of presentation steps are provided, and the plurality of presentation steps are sequentially executed in a fixed order, or a plurality of presentation steps are provided, and the plurality of presentation steps are executed based on the trigger conditions.

21. (canceled)

22. The human-computer interaction system for mixed reality according to claim 15, wherein the trigger conditions comprise at least one of a time condition, a position condition, an orientation condition, a user input event, a pre-stored program script, and a custom program script, or the trigger condition is a combination of a plurality of trigger conditions that have undergone logical operations.

23. (canceled)

24. (canceled)

25. (canceled)

26. The human-computer interaction system for mixed reality according to claim 13, wherein a configuration manner of the placement pose of the virtual content item in the 3D space comprises:
obtaining a reference position based on the 3D space;
moving the virtual content item to a target placement position via an anchor bound to the virtual content item, calculating and recording a relationship between the anchor and the reference position, and defining the position of placement as an anchor position; and
determining the placement pose of the virtual content item based on the anchor position.

27. The human-computer interaction system for mixed reality according to claim 17, wherein the reference position is obtained by identifying and localizing a reference object in the 3D space, the reference object comprises at least an environment, an object. or a marker.

28. (canceled)

29. The human-computer interaction system for mixed reality according to claim 17, wherein the anchor is a handheld mobile device, the anchor carries a localization pattern, and the anchor position is obtained by identifying and localizing the localization pattern, the localization pattern comprises an image, a two-dimensional code, a barcode, or a specific graphic.

30. (canceled)

31. (canceled)

32. The human-computer interaction system for mixed reality according to claim 19, wherein an image capture device mounted on a head-mounted display device is used to identify and localize the reference object and the localization pattern.

33. The human-computer interaction system for mixed reality according to claim 17, wherein the anchor position is determined as the placement pose of the virtual content item, or the placement pose of the virtual content item is determined after a mathematical operation is performed on the anchor position.

34. (canceled)

35. A human-computer interaction apparatus for mixed reality, used in the method of claim 1, wherein the apparatus comprises at least one processor, at least one handheld mobile device, and at least one head-mounted display device, wherein
the processor is configured to perform the step of presentation process design;
the handheld mobile device is configured to cooperate with the head-mounted display device to perform the step of content arrangement; and
the head-mounted display device is configured to perform the step of presentation use.

36. The human-computer interaction apparatus for mixed reality according to claim 22, wherein the processor is integrated in the head-mounted display device.

37. The human-computer interaction apparatus for mixed reality according to claim 22, wherein the processor is integrated in the handheld mobile device.
